(19) United States
(12) Patent Application Publication
(10) Pub. No.: US 2011/0103611 A1
(43) Pub. Date: May 5, 2011

(54) HEARING DEVICE AND METHOD FOR SUPPRESSING FEEDBACK WITH A DIRECTIONAL MICROPHONE

(75) Inventors: GEORG-ERWIN ARNDT, OBERMICHELBACH (DE); JENS HAIN, KLEINSENDELBACH (DE); SEBASTIAN PAPE, ERLANGEN (DE)

(73) Assignee: SIEMENS MEDICAL INSTRUMENTS PTE. LTD., SINGAPORE (SG)

(21) Appl. No.: 12/910,965

(22) Filed: Oct. 25, 2010

(30) Foreign Application Priority Data
Oct. 29, 2009 (DE) 10 2009 051 200.4

(51) Int. Cl. H04R 3/00

(52) U.S. Cl. 381/92

(57) ABSTRACT

A hearing device and an associated method use an adaptive directional microphone for suppressing feedback. The hearing device includes an adaptation unit which sets the directional microphone so that a sound signal fed back from an earpiece of the hearing device to the directional microphone is attenuated. Acoustic feedback is advantageously attenuated or suppressed simply in an artifact-free manner.

### CROSS-REFERENCE TO RELATED APPLICATION

This application claims the priority, under 35 U.S.C. §119, of German Patent Application DE 10 2009 051 200.4, filed Oct. 29, 2009; the prior application is herewith incorporated by reference in its entirety.

### BACKGROUND OF THE INVENTION

### Field of the Invention

The invention relates to a method and a hearing device for suppressing or compensating for acoustic feedback with the aid of the directional effect of an adaptive directional microphone.

A frequent problem with hearing apparatuses is the feedback between the output and the input of the hearing apparatus, which is perceived as disruptive feedback whistling. FIG. 1 shows the principle of acoustic feedback using the example of a hearing device 1. The hearing device 1 includes a microphone 2, which receives a useful acoustic signal 10, converts it to an electrical microphone signal 11 and emits it to a signal processing unit 3. In the signal processing unit 3, the microphone signal 11 is, for example, processed and amplified and emitted as an earpiece signal 12 to an earpiece 4. In the earpiece 4, the electrical earpiece signal 12 is converted back to an acoustic output signal 13 and emitted to the eardrum 7 of a hearing device wearer.

The problem is that some of the acoustic output signal 13 reaches the input of the hearing device 1 by way of an acoustic feedback path 14 and is overlaid there with the useful signal 10 and received by the microphone 2 as a sum signal. Disruptive feedback whistling results with a suitable phase relation and amplitude of the feedback output signal. Attenuation of the acoustic feedback is low in particular due to an open hearing device supply, thereby exacerbating the problem.

Adaptive systems for suppressing feedback have been available for some time now to resolve that problem. With those systems, the acoustic feedback path 14 is simulated digitally. Simulation takes place, for example, through the use of an adaptive compensation filter 5, which is fed by the signal 12 driving the earpieces. After filtering in the compensation filter 5, a filtered compensation signal 15 is subtracted from the microphone signal 11. Ideally, the effect of the acoustic feedback path 14 is eliminated as a result and an input signal 16 with feedback compensation results in the signal processing unit 3.

It is necessary to regulate or adjust the filter coefficient of the adaptive compensation filter 5 for effective feedback suppression. To that end an analysis unit 6 is used to evaluate the input signal 16 of the signal processing unit 3 and to check for possible feedback. Adjustment can produce artifacts, since additional signal components are generated if the compensation filters 5 are not optimally adaptive. Feedback whistling can also occur with a compensation filter 5 that is not optimally adapted. European Patent EP 1 033 063 B1, corresponding to U.S. Pat. Nos. 6,072,884; 6,097,824; 6,104,822; 6,219,427; 6,484,246; 6,498,858; and 6,831,986, discloses such a hearing device, wherein two adaptive compensation filters operating in parallel are used to improve feedback suppression.

Directional microphone systems are among the methods now used for some years to suppress interference noise and are proven to improve the comprehensibility of speech in hearing situations where the useful signal and interference signals arrive from different directions. In modern hearing devices the directional effect is produced by the differential processing of two or more adjacent microphones with omnidirectional characteristics.

FIG. 2 shows a simplified block diagram of a first order directional microphone system having two microphones 21, 22 at a distance of about 10 to 15 mm. An external delay of T2 therefore results between the first and second microphones 21, 22 for sound signals coming from the front V which corresponds, for example, to the distance between the microphones 21, 22. A signal R2 of the second microphone 22 is delayed by a time T1 in a delay unit 23, inverted in an inverter 24 and added to a signal R1 of the first microphone 21 in a first adder 25. The sum produces a directional microphone signal RA which can be fed, for example, by way of signal processing to an earpiece. The directionally dependent sensitivity results substantially from a subtraction of the second microphone signal R2 delayed by the time T2 from the first signal R1. Sound signals from the front V are thus not attenuated after appropriate equalization while, for example, sound signals from the rear S are eliminated.

Adaptive directional microphones are microphones which are able to adjust to different ambient situations during ongoing operation. The aim thereof is generally to receive and forward useful sound emitted from a useful sound source as efficiently as possible, while the interference sound from one or more interference sound sources is to be attenuated as effectively as possible in the output signal emitted by the adaptive directional microphone. A hearing device with an adaptive directional microphone is known from International Publication No. WO 00/19770 A1, corresponding to U.S. Pat. No. 6,751,325, wherein the directionally dependent amplification/attenuation can be varied according to the result of a signal analysis.

### SUMMARY OF THE INVENTION

It is accordingly an object of the invention to provide a hearing device and a method for suppressing feedback with a directional microphone, which overcome the hereinafore-mentioned disadvantages of the heretofore-known devices and methods of this general type, which are simple and provide feedback suppression with minor artifacts.

With the foregoing and other objects in view there is provided, in accordance with the invention, a method for suppressing feedback in a hearing device. The method comprises providing the hearing device with an adaptive directional microphone and an earpiece and attenuating a sound signal fed back from the earpiece to the directional microphone by adaptation of the directional microphone. In other words the directional characteristic of the directional microphone features a notch in the direction of the feedback path. The invention has the advantage that acoustic feedback is attenuated simply in an artifact-free manner.

In accordance with another mode of the invention, it is only possible to attenuate in predeterminable frequency bands. This means that undisrupted directional microphone operation can take place in the other frequency bands.

In accordance with a further mode of the invention, attenuation can only take place in those frequency bands in which feedback occurs. This has the advantage that other frequency bands are not influenced.

In accordance with an added mode of the invention, the frequency bands can also be determined by Open Loop Gain (OLG) measurement.

In accordance with an additional mode of the invention, white noise can be emitted by the earpiece. The feedback signal components of the white noise received by the directional microphone are attenuated in that the directional microphone adjusts its directional characteristic by changing adaptation parameters. Adaptation is stopped when attenuation exceeds a predeterminable threshold value. The adaptation parameters thus determined are then stored. In other words they are “frozen” for further use. The threshold value may be a maximum attenuation. This has the advantage that the optimum settings of the adaptive directional microphone can be determined in a hearing device adjustment session.

In accordance with yet another mode of the invention, the level of the frequency bands with feedback after feedback suppression can be adjusted to the level of adjacent frequency bands. This provides the sound pattern even if independent directional microphone operation takes place in frequency bands without feedback.

In accordance with yet a further mode of the invention, the directional microphone can also be operated with the stored adaptation parameters. This insures operation with a low level of feedback.

With the objects of the invention in view, there is also provided a hearing device, comprising an earpiece, an adaptive directional microphone for suppressing feedback and an adaptation unit setting the directional microphone for attenuating a sound signal fed back from the earpiece to the directional microphone.

In accordance with another feature of the invention, only predeterminable frequency bands are attenuated.

In accordance with a further feature of the invention, the hearing device can only attenuate in those frequency bands in which feedback occurs.

In accordance with an added feature of the invention, the hearing device can also include the following units:
a noise signal unit, which emits white noise by way of the earpiece,
a control unit to determine adaptation parameters of the adaptation unit, which controls the adaptation of the directional microphone by changing the adaptation parameters so that the feedback signal components of the white noise received by the directional microphone are attenuated and which stops the adaptation when attenuation exceeds a threshold value or a maximum attenuation, and
a storage unit to store the adaptation parameters thus determined.

In accordance with an additional feature of the invention, the hearing device can also include a level adjustment unit which adjusts the level of the frequency bands with feedback after feedback suppression to the level of adjacent frequency bands without feedback.

In accordance with a concomitant feature of the invention, the hearing device can include at least two omnidirectional microphones emitting microphone signals, which are connected electrically to one another in the adaptation unit to form a directional characteristic.

Other features which are considered as characteristic for the invention are set forth in the appended claims.

Although the invention is illustrated and described herein as embodied in a hearing device and a method for suppressing feedback with a directional microphone, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic and block diagram of a hearing device with feedback suppression according to the prior art;

FIG. 2 is a schematic and block diagram of a microphone configuration with directional characteristics according to the prior art;

FIG. 3 is a flow diagram of a method for suppressing feedback with an adaptive directional microphone, according to the present invention;

FIG. 4 is a schematic and block diagram of a hearing device with feedback suppression through the use of a directional microphone according to the present invention; and

FIG. 5 is a graph showing measurement curves of frequency-dependent feedback in a hearing device according to the present invention.

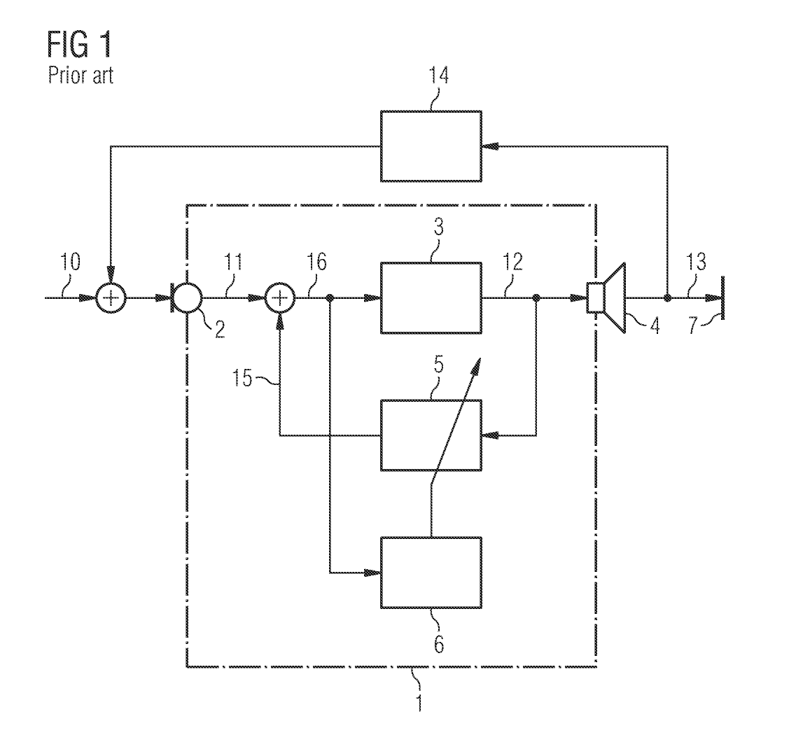

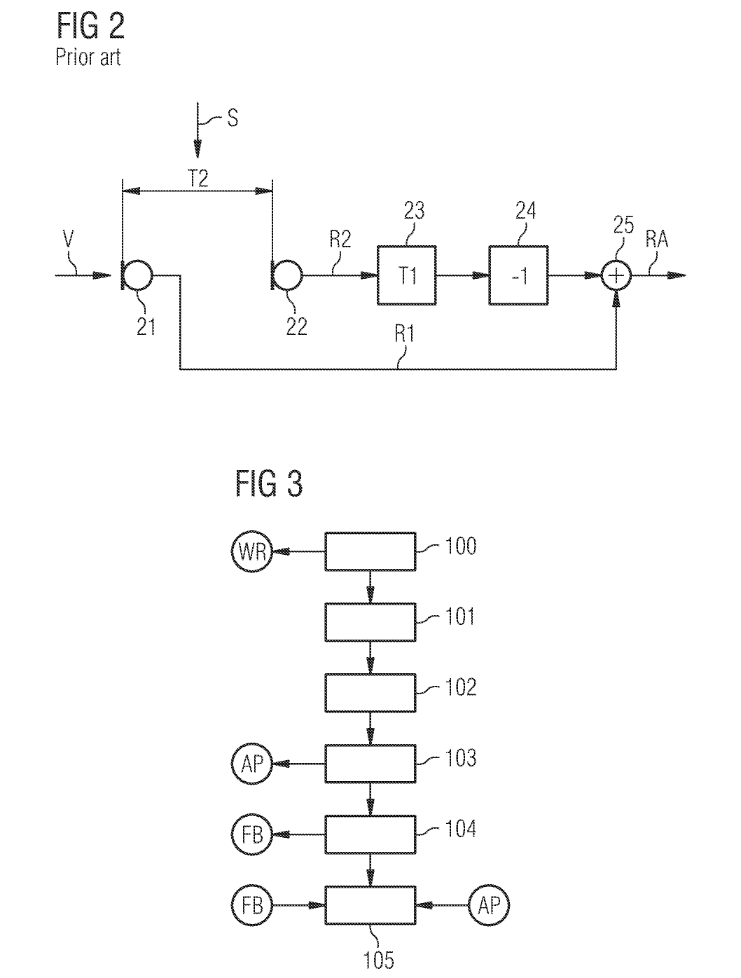

### DETAILED DESCRIPTION OF THE INVENTION

Referring now to the figures of the drawings in detail and first, particularly, to FIG. 3 thereof, there is seen a flow diagram of a method for feedback suppression in hearing devices with the aid of an adaptive directional microphone. In a first step 100, white noise WR is emitted from an earpiece of a hearing device worn by a hearing device wearer in a measuring booth with the best possible soundproofing. An acoustic feedback path between the earpiece of the hearing device and at least one microphone of the directional microphone causes signal components of the white noise to be received by the microphone. In a step 101, adaptation parameters AP of the adaptive directional microphone are changed so that the feedback signal components are attenuated.

In a step 102, adaptation is stopped, when the signal components of the feedback white noise have been attenuated by a predeterminable threshold value. The threshold value may be a maximum attenuation. In a step 103, the adaptation parameters AP thus determined are stored. Attenuation preferably only takes place in those frequency bands FB, in which feedback occurs. These are determined by using an OLG measurement in step 104. In a step 105, the hearing device is operated with the adaptation parameters AP thus determined and the frequency bands FB thus determined.

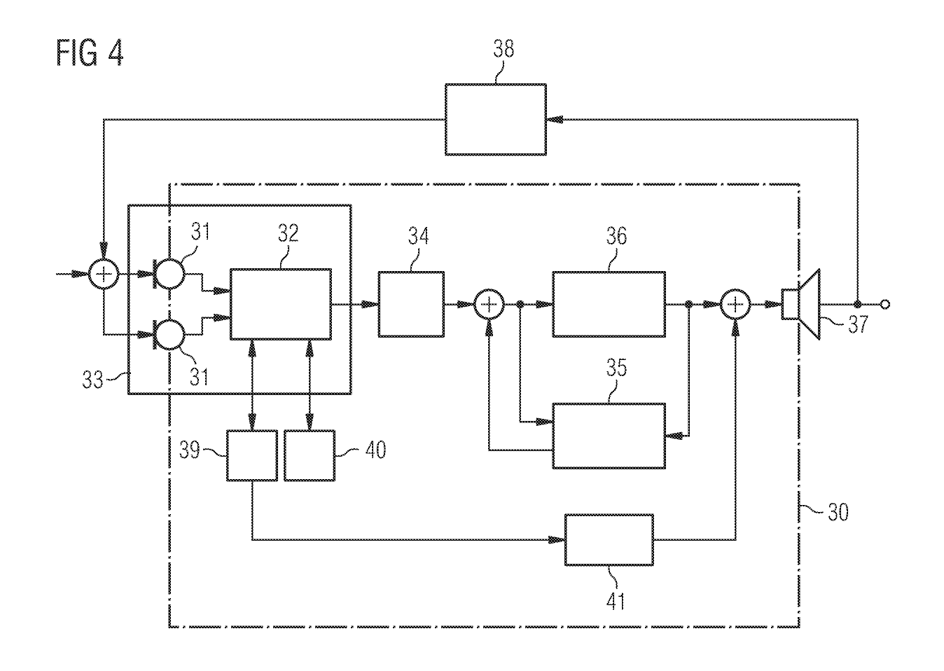

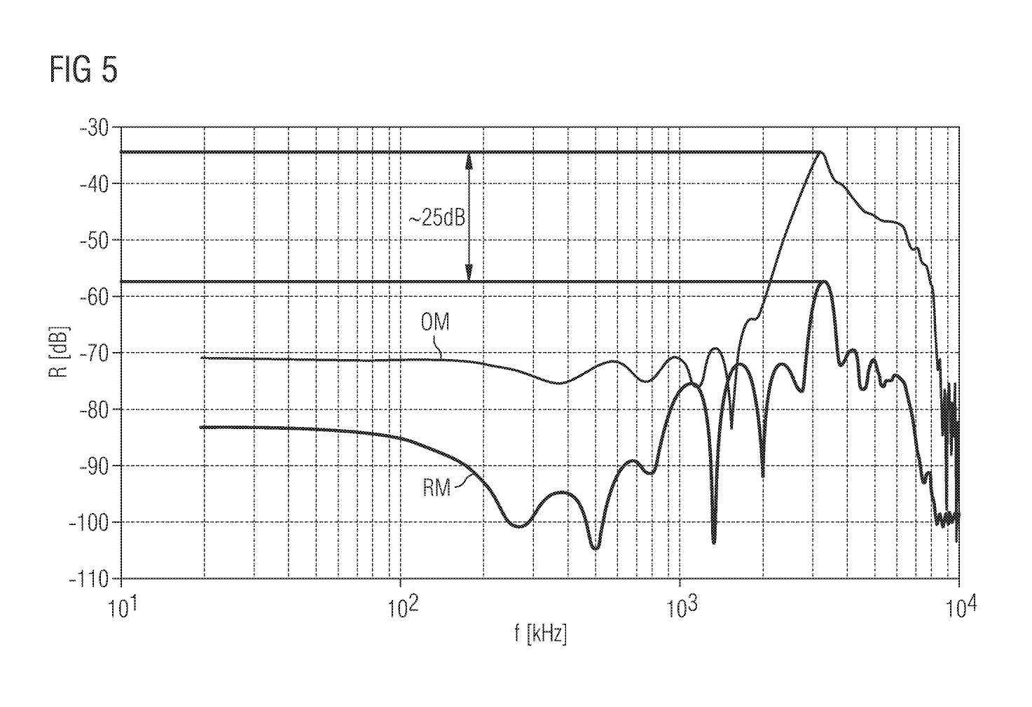

FIG. 4 shows a block diagram of a hearing device 30 with a directional microphone 33 to suppress acoustic feedback. Sound signals are received by two omnidirectional microphones 31, converted to electrical signals and fed to an adaptation unit 32. The microphone signals of the two microphones 31 are connected electrically to one another in the adaptation unit 32. It is possible to change the directional characteristic of the directional microphone 33 formed by the microphones 31 by changing adaptation parameters in the adaptation unit 32.

A directional microphone signal leaves the adaptation unit 32 and is fed to a level adjustment unit 34. It is possible to adjust the signal levels of different frequency bands to one another as required with the aid of the level adjustment unit 34. The signal thus adjusted is fed to a signal processing unit 36 and leaves the same amplified and prepared. The signal processed by the signal processing unit 36 is fed to an earpiece 37 and emitted thereby as a sound signal. Part of the sound signal is fed back by way of an acoustic feedback path 38 to the microphones 31 and can cause feedback whistling. Therefore, a control unit 39 is used to change the adaption parameters of the adaptation unit 32 so that the feedback signal components are attenuated. In other words, the notch of the directional characteristic of the directional microphone 33 points in the direction of the feedback path.

The adaptation parameters are preferably determined in a hearing device adjustment session. To this end white noise is emitted from the earpiece 37 with the aid of a noise signal unit 41 in the hearing device 30. Some of this white noise is fed back acoustically and received by the microphones 31. The adaptation parameters of the adaptation unit 32 are now changed until the feedback noise signal is attenuated by a predeterminable threshold value. The adaptation parameters thus determined are stored in a storage unit 40 and used during hearing device operation.

Advantageously, only those frequency bands in which feedback occurs are attenuated. The critical frequency bands are determined, for example, through the use of OLG measurement.

In order to avoid sound differences for signals from the rear in non-attenuated frequency bands during directional microphone operation, the level adjustment unit 34 aligns the levels of the attenuated frequency bands with the levels of adjacent frequency bands.

FIG. 5 shows a diagram of a signal level R in dB as a function of frequency f in kHz for a sound signal fed back into an omnidirectional microphone and for a sound signal fed back into a directional microphone with a 70° notch.

It is clear from the two level curves OM and RM of the omnidirectional microphone and the directional microphone that feedback occurs at a frequency f of around 3 kHz, with the feedback in the directional microphone being around 25 dB lower than in the omnidirectional microphone due to the selected 70° directional effect.

1. A method for suppressing feedback in a hearing device, the method comprising the following steps:
providing the hearing device with an adaptive directional microphone and an earpiece; and
attenuating a sound signal fed back from the earpiece to the directional microphone by adaptation of the directional microphone.

2. The method according to claim 1, which further comprises carrying out the attenuating step only in predeterminable frequency bands.

3. The method according to claim 2, which further comprises carrying out the attenuating step only in those frequency bands in which feedback occurs.

4. The method according to claim 3, which further comprises determining the frequency bands by Open Loop Gain measurement.

5. The method according to claim 1, which further comprises:
emitting white noise with the earpiece;
adapting the directional microphone by changing adaptation parameters to attenuate feedback signal components of the white noise received by the directional microphone;
stopping the adaptation when attenuation exceeds a threshold value; and
storing the adaptation parameters.

6. The method according to claim 2, which further comprises adjusting a level of the frequency bands with feedback after feedback suppression, to a level of adjacent frequency bands.

7. The method according to claim 5, which further comprises operating the directional microphone with the stored adaptation parameters.

8. A hearing device, comprising:
an earpiece;
an adaptive directional microphone for suppressing feedback from said earpiece; and
an adaptation unit setting said directional microphone for attenuating a sound signal fed back from said earpiece to said directional microphone.

9. The hearing device according to claim 8, wherein said directional microphone only attenuates in predeterminable frequency bands.

10. The hearing device according to claim 9, wherein said directional microphone only attenuates in frequency bands in which feedback occurs.

11. The hearing device according to claim 8, which further comprises:
a noise signal unit emitting white noise with said earpiece;
a control unit connected to said noise signal unit for determining adaptation parameters of said adaptation unit, for controlling adaptation of said directional microphone by changing adaptation parameters to attenuate feedback signal components of the white noise received by said directional microphone and for stopping the adaptation when attenuation exceeds a threshold value; and
a storage unit connected to said adaptation unit for storing the adaptation parameters thus determined.

12. The hearing device according to claim 11, wherein said directional microphone only attenuates in predeterminable frequency bands, and a level adjustment unit is connected to said adaptation unit for adjusting a level of the frequency bands with feedback after feedback suppression, to a level of adjacent frequency bands without feedback.

13. The hearing device according to claim 11, wherein said directional microphone includes at least two omnidirectional microphones emitting microphone signals, said omnidirectional microphones being electrically connected to one another in said adaptation unit to form a directional characteristic.
